(19) United States
(12) Patent Application Publication
(10) Pub. No.: US 2005/0246264 A1
(43) Pub. Date: Nov. 3, 2005

(54) Method of managing research/advisory service provider payments

(75) Inventor: Michael Plunkett, Glen Head, NY (US)

Correspondence Address: FITZPATRICK CELLA HARPER & SCINTO, 30 ROCKEFELLER PLAZA, NEW YORK, NY, 10112, US

(73) Assignee: INSTINET L.L.C., New York, NY (US)

(21) Appl. No.: 10/837,174

(22) Filed: Apr. 30, 2004

(51) Int. Cl. G06F 17/60

(52) U.S. Cl. 705/37

(57) ABSTRACT

A method for an electronic trading system is provided. This method includes the steps of allocating a portion of a trade commission received from a client to a research account, and accumulating, over a plurality of trades, the commissions allocated to the research account. The electronic trading system receives a request from the client to pay a specified amount from the research account to a designated research or advisory service provider, and pays the specified amount to the designated provider.

### BACKGROUND OF THE INVENTION

1. Field of the Invention

The present invention relates to a method of managing payments to research and/or advisory service providers using an electronic trading system.

2. Related Art

Traditionally consumers, including but not limited to institutional and individual investors, have used full service broker-dealers (such as Merrill Lynch, Smith Barney, etc.) to place and execute trades of securities and other financial instruments. The consumers may base all or part of their trades on the research and advice generated and provided to them by their broker-dealer. The costs for the research and advice are typically built into the broker-dealer's trade commissions.

In recent years, in an effort to reduce their commission payments, consumers have moved away from traditional full service broker-dealers to electronic trading systems to place and execute trade orders. One such well known electronic trading system is operated by Instinet Corporation, the assignee of the present application. Upon submission of a trading order by the consumer (hereinafter, the “client”), the electronic trading system executes the trade, and in turn receives a trade execution commission payment from the client.

The electronic trading systems usually have lower commissions than full service broker-dealers, because electronic trading systems do not provide research and advisory services. Thus, if a client uses an electronic trading system to place and execute trades, but still wishes to obtain a broker-dealer's trading research and advice, or that of research or advisory service boutiques, the client must separately pay, or make arrangements for paying, the broker-dealer or boutiques. Of course, because the broker-dealer is only providing research or advice, these payments do not include the trade execution commissions.

FIG. 1 shows one traditional way of paying for research and advisory services generated and provided by full service broker-dealers, research boutiques, or advisory service boutiques 101, in the form of a “step-out arrangement.” As stated above, research and advisory services are provided to the client (e.g., to the client's portfolio manager 102). The client places a trade order with the trader 103 (e.g., an electronic trading system) for execution. Note that the trade order need not be linked to the research or advice. The trader executes the trade and receives a commission for doing so, and out of that commission pays the full service broker-dealer, research boutique, and/or service provider in accordance with a prior step-out agreement (the payment may be made in “soft dollars,” for example $1.00 of soft dollar products and services for every $2.00 in commissions, rather than actual hard currency). Thus, the trader who executes the trade gives some of the commission to the research/advisory service provider.

However, using step-out arrangements may cause a client's confidential trading strategy and/or market position to be divulged. Specifically, based on the step-out payments, research/advisory service providers may be able to derive the client's trading strategy and/or market position, and potentially use that knowledge to the detriment of the client. Further, administering and tracking step-out payments on a large volume of trades places an onerous burden on both the trader and client. In addition, not all broker-dealers are willing to participate in such step-out arrangements, forcing the client to maintain more trading relationships with broker-dealers than desired.

### SUMMARY OF THE INVENTION

To overcome the above-described limitations in the art, the present invention allows a client to use an electronic trading system to execute trades, while independently directing payments to research/advisory service providers without the need of a step-out arrangement. The client can thus fully use an electronic trading system while also receiving products and services from top-tier investment research and advisory service providers, allowing the clients to consolidate the number of trading relationships they maintain. Further, because step-out arrangements are eliminated, the confidentiality of the client's trading strategy and/or market position can be maintained, and the efficiency of administering and tracking the research/advisory payments can be increased.

In one aspect of the present invention, a method for an electronic trading system is provided. This method includes the steps of allocating a portion of a trade commission received from a client to a research account, and accumulating, over a plurality of trades, the commissions allocated to the research account. Another portion of the trade commission may be allocated to a trade account. The trade commission results from the electronic trading system executing a trade of a financial instrument for the client.

In another aspect of the present invention, the electronic trading system receives a request from the client to pay a specified amount from the research account to a designated research or advisory service provider. The electronic trading system pays the specified amount to the designated provider. Prior to such payment, an agreement is established between the electronic trading system provider and the designated provider.

In yet another aspect of the present invention, one or more of the steps of the method of the present invention are carried out by software code executing on a computer of the electronic trading system.

### BRIEF DESCRIPTION OF THE DRAWINGS

These and other aspects of the present invention will be more clearly understood by reference to the following detailed description of exemplary embodiments in conjunction with the accompanying drawings, in which:

FIG. 1 is a block diagram showing a conventional research payment method using a step-out agreement.

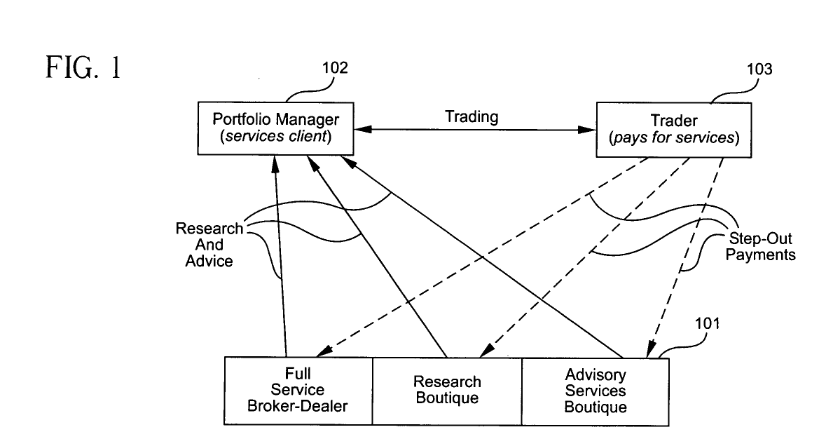

FIG. 2A is an overall block diagram of the present invention.

FIG. 2B is an expanded block diagram of the present invention.

### DETAILED DESCRIPTION OF THE INVENTION

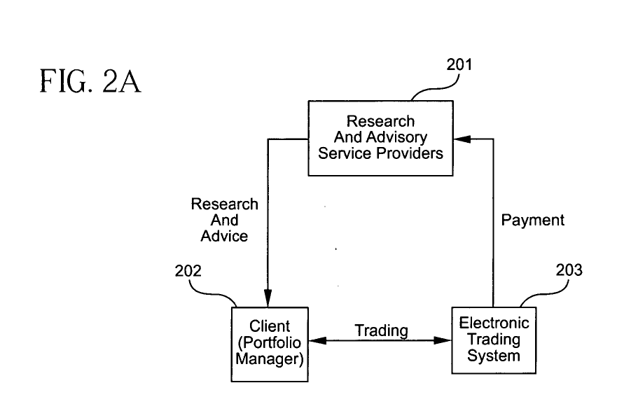

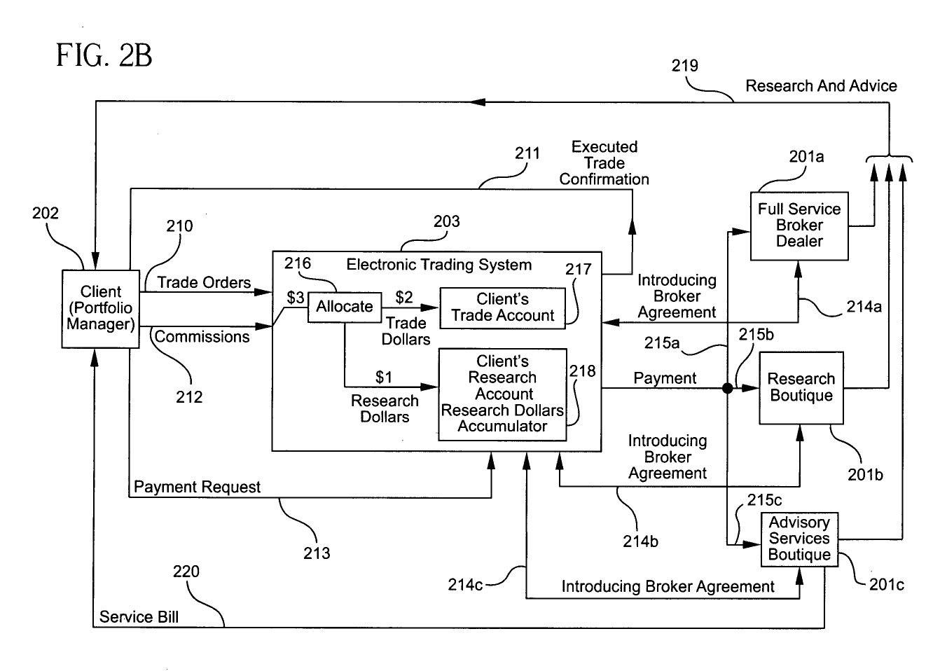

FIG. 2A is an overall block diagram of one embodiment of the present invention. Research and advisory service providers 201, including full service broker-dealers 201a, research boutiques 201b, and advisory service boutiques 201c (see FIG. 2B), generate and provide investment research and advice concerning securities and other financial instruments to a client 202, usually a portfolio or money manager for an institutional investor (such as a mutual find, an insurance company, a pension fund, etc.). The research and advisory service providers, the clients, and financial instruments are not limited to the above example, and may constitute other types of service providers, clients and financial instruments that are within the knowledge of those skilled in the art. The client places trade orders with the electronic trading system 203, usually electronically, which in turn executes the trade and collects a trade commission from the client. As will be described in more detail below, the client's trade commissions are managed in such a manner as to permit the electronic trading system to make a payment to one or more research and advisory service providers under the client's direction.

As shown in FIG. 2B, the client 202 places a trade order 210 to an electronic trading system 203. The electronic trading system executes the trade, and provides a confirmation of the executed trade 211 to the client. The client remits the trade commission 212 to the electronic trading system. All of these steps are done in conventional fashion, usually electronically over an electronic communications network (“ECN,” not shown), as is well known in the art. The electronic trading system comprises one or more computers and related hardware and trading software, all of which are also well known in the art.

The client, independent of the electronic trading system, receives research and advice 219 from a full service broker-dealer 201a, a research boutique 201b, and/or an advisory services boutique 201c, all of which are also known in the art. This research and advice need not be related to the trade orders placed by the client. Every so often, in accordance with their standard practice, the research and advisory service providers 201a, 201b and/or 201c send a bill 220 for their services to the client.

The electronic trading system receives a commission payment amount (either from an electronic funds transfer, or via an input by a system operator as derived from a check, money order, or other conventional form of payment). Execution of allocation software code 216, stored in the electronic trading system's computer memory, on the electronic trading system's processing unit, causes the commission payment amount to be allocated into two client accounts: the client's trade account 217 and the client's research account 218, both of which may be stored electronically in the electronic trading system's memory. The degree of allocation between the accounts is based on a policy between the client and the electronic trading system provider, either predetermined by agreement or established through custom and usage. For example, the client and the electronic trading system provider may agree that for every three dollars in commission received, two dollars go to the client's trading account to pay for execution of the specific trade, and one dollar goes to the research account. While the trade dollars are trade specific, the client's research dollars are not and instead accumulate over all of the client's trades over all time.

Upon a payment request 213 by the client, which may be electronically (e-mail, telephone or the like) or manually made (i.e., a conventional letter) and indicates at minimum the payment amount(s) and the name of the research/advisory service provider(s) to be paid, the electronic trading system disburses (by check, electronic fund transfer, or otherwise) from the client's research account the payment(s) 215a, 215b, and/or 215c respectively to the research/advisory service provider(s) 201a, 201b, and/or 201c. For example, the client may simply request that $20,000 be paid to Merrill Lynch, and the electronic trading system causes the electronic transfer of that amount to Merrill Lynch (or the electronic trading system provider cuts a check or the like), and debits $20,000 from the client's research account.

All that is required before payment can be made from client's research account is the establishment of an introducing broker agreement 214a, 214b, and/or 214c between the electronic trading system and the service providers 201a, 201b, and/or 201c for that client. That agreement gives permission for the electronic trading system to pay the service provider directly from the client's research account. This agreement does not have to be in place at the time of collection/ accumulation, which accords with the fact that the collection and accumulation of research dollars is not tied to any particular service provider. For example, establishing the introducing broker agreement may occur long after the collection and accumulation of research dollars and just immediately before a payment is made, or long before any collection/accumulation and payment of research dollars, or at any time in between collection/accumulation and payment.

As shown in FIG. 2B, the amount in the research account is accumulated over all trades by the client over a period of time. Thus, after a year of trading, the client may have paid the electronic trading system a total of $150,000 in commissions, $50,000 of which is accumulated in the research account. The money in the client's research account is not tied to any specific service provider, and as stated above, it may be collected and accumulated long before there is any relation between the client and the service provider. Moreover, the money in the research account is not tied to any specific trade—it is commingled over all of the client's trades over all time. The research account is simply a growing pot of money earmarked for future payments to service providers, which may be unknown at the time of collection and accumulation.

In addition, there is no fixed time to disburse the accumulated research dollars. Disbursement is done only upon and at the time of the client's request (assuming there is enough money in the account to accommodate the request and that the required introducing broker agreement is in place), and in fact may occur years after the money has been collected. The payment request 213 does not even have to be tied, time-wise or otherwise, to the service bill 220. Further, unlike payments made under a step-out arrangement, the payment to the service provider in the present invention is not linked to, and thus cannot be traced back to any specific trade, thereby maintaining the confidentiality of the client's trading strategy and/or market position.

In addition, for a given client, multiple service providers may be paid from the same research account, using one or more payment requests. Also, unlike step-out arrangements, the electronic trading system of the present invention does not receive any service provider bills—as mentioned above, the bills 220 are sent directly to the client. Because the payments are not linked to specific trades, because only one research account is kept for the client, and because the electronic trading system does not receive service bills, efficiency in administering and tracking the payments is increased for the electronic trading system.

While the present invention has been particularly shown and described with respect to the preferred embodiments thereof, it will be understood by those skilled in the art that changes in form and details may be made without departing from the scope and spirit of the invention.

1. A method for an electronic trading system, said method comprising the steps of:
allocating a portion of a trade commission received from a client to a research account; and
accumulating, over a plurality of trades, the commissions allocated to the research account.

2. The method according to claim 1, further comprising the step of receiving a request from the client to pay a specified amount from the research account to a designated service provider.

3. The method according to claim 2, further comprising the step of paying the specified amount to the designated provider.

4. A method according to claim 3, further comprising the step of establishing an agreement between a provider of the electronic trading system and the designated provider prior to paying the specified amount to the designated provider.

5. The method according to claim 1, further comprising the step of executing a trade of a financial instrument for the client, resulting in the received trade commission.

6. The method according to claim 1, wherein said steps are carried out by software code executing on a computer of the electronic trading system.

7. The method according to claim 1, further comprising the step of allocating another portion of the trade commission to a trade account.
